(19) United States
(12) Patent Application Publication
(10) Pub. No.: US 2026/0270500 A1
(43) Pub. Date: Sep. 10, 2026

(54) INTERFACE INTERACTION

(71) Applicant: Bytedance Technology Ltd., Grand Cayman (KY)

(72) Inventors: Zichun WANG, Culver City, CA (US); Yue CHEN, Beijing (CN); Siyuan CHEN, Culver City, CA (US); Hao QIU, Culver City, CA (US); Jinyi WANG, Beijing (CN)

(21) Appl. No.: 19/562,447

(22) Filed: Mar. 10, 2026

(30) Foreign Application Priority Data
Mar. 10, 2025 (CN) 202510278939.2

(51) Int. Cl. H04N 21/431; H04N 21/4788; H04N 21/482

(52) U.S. Cl. CPC H04N 21/4312; H04N 21/4788; H04N 21/482

(57) ABSTRACT

Embodiments of this disclosure relates to a method, apparatus, device and storage medium for interface interaction. The method includes: receiving an interaction request of a user for media content; presenting, in response to the interaction request, a set of visual avatars associated with the user; and constructing, in response to a selection of a first visual avatar from the set of visual avatars, first interactive content associated with the media content, where the first interactive content displays the first visual avatar. In this way, the embodiments of this disclosure can visually display the interactive content.

### CROSS-REFERENCE

The present application claims priority to Chinese Patent Application No. 202510278939.2, filed on Mar. 10, 2025, and entitled “METHOD, APPARATUS, DEVICE AND STORAGE MEDIUM FOR INTERFACE INTERACTION”, the entirety of which is incorporated herein by reference.

### FIELD

Example embodiments of the present disclosure generally relate to the field of computers, and in particular, to interface interaction.

### BACKGROUND

With the continuous development of Internet technologies, more and more users perform interactive activities in a network platform, for example, publishing or browsing media content in the network platform, recommending or commenting for the media content, and interacting with different users for the same media content and the like.

### SUMMARY

In a first aspect of the present disclosure, a method for interface interaction is provided. The method comprises: receiving an interaction request of a user for media content; presenting, in response to the interaction request, a set of visual avatars associated with the user; and constructing, in response to selection of a first visual avatar from the set of visual avatars, first interactive content associated with the media content, where the first interactive content displays the first visual avatar.

In a second aspect of the present disclosure, an apparatus for interface interaction is provided. The apparatus comprises: a request receiving module, an avatar presenting module and a content construction module, wherein the request receiving module is configured to receive an interaction request of a user for media content; the avatar presenting module is configured to present, in response to the interaction request, a set of visual avatars associated with the user; and the content construction module is configured to construct, in response to a selection of a first visual avatar from the set of visual avatars, first interactive content associated with the media content, where the first interactive content displays the first visual avatar.

In a third aspect of the present disclosure, an electronic device is provided. The electronic device comprises at least one processor; and at least one memory coupled to the at least one processor and storing instructions for execution by the at least one processor. The instructions, when executed by the at least one processor, cause the electronic device to perform the method of the first aspect.

In a fourth aspect of the present disclosure, a computer-readable storage medium is provided. The computer-readable storage medium stores a computer program, and the computer program is executable by the processor to implement the method of the first aspect.

It should be understood that the content described in this summary section is not intended to limit key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments according to the present disclosure may be implemented;

FIGS. 2A-2H illustrate example interfaces according to some embodiments of the present disclosure;

FIGS. 3A-3F illustrate example interfaces according to some embodiments of the present disclosure;

FIGS. 4A-4F illustrate example interfaces according to some embodiments of the present disclosure;

FIG. 5 illustrates a flowchart of an example process of implementing interface interaction according to some embodiments of the present disclosure;

FIG. 6 illustrates a flowchart of an example process of interface interaction according to some embodiments of the present disclosure;

FIG. 7 illustrates a schematic structural block diagram of an example apparatus for interface interaction according to some embodiments of the present disclosure; and

FIG. 8 illustrates a block diagram of an electronic device capable of implementing various embodiments of the present disclosure.

### DETAILED DESCRIPTION

Embodiments of the present disclosure will be described in more detail below with reference to the accompanying drawings. Although some embodiments of the present disclosure are shown in the accompanying drawings, it is to be understood that the present disclosure may be implemented in various forms, and should not be interpreted as limited to embodiments set forth herein. On the contrary, these embodiments are provided for a more thorough and complete understanding of the present disclosure. It is to be understood that the drawings and embodiments of the present disclosure are merely for example purposes and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with any other embodiments described in the same section/subsection and/or different section/subsection.

In the description of embodiments of the present disclosure, the term “comprising” and the like should be understood as openness, i.e., “comprising but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first”, “second” and the like may refer to different or identical objects. Other explicit and implicit definitions may also be included below.

Embodiments of the present disclosure may relate to data of a user, obtaining and/or usage of the data, and the like. These aspects all follow the corresponding laws and regulations and related regulations. In the embodiments of the present disclosure, all data collection, obtaining, handling, processing, forwarding, usage, etc. are conducted with the user’s knowledge and consent. Accordingly, when implementing the various embodiments of the present disclosure, types, usage scopes, usage scenarios, and the like of the data or information that may be involved should be informed to the users and obtain user authorization in an appropriate manner according to the relevant laws and regulations. A specific notification and/or authorization manner may vary according to actual situations and application scenarios, and the scope of the present disclosure is not limited in this respect.

The solutions in the present specification and the embodiments, if personal information processing is involved, may be processed on the premise of having a legality basis (for example, obtaining consent of a personal information subject, or being necessary for performing a contract, etc.), and may be processed only within a specified or agreed range. The user rejects personal information other than necessary information required for basic functions, and will not affect use of basic functions.

As mentioned above, more and more users perform interactive activities in a network platform, such as a social platform and a short video interaction platform. The user may publish or browse interaction information, for example, text content, furthermore, media content such as a video, in the related network platform. And the user may favorite, comment, forward, recommend, and the like on the related interaction information. In addition, the user may interact with other users for interaction information such as the same media content.

In the related art, interaction forms of a user for media content are relatively limited. For example, if the amount of interaction information such as recommendation or comment associated with the media content is relatively large, the user can only view and acknowledge by clicking details. For another example, the user can only express the interaction content in a conventional form such as text or a general expression, so that the representation form of the interaction content is limited.

Embodiments of the present disclosure provide an interface interaction solution. The solution comprises: receiving an interaction request of a user for media content; presenting, in response to the interaction request, a set of visual avatars associated with the user; and constructing, in response to a selection of the first visual avatar from the set of visual avatars, first interactive content associated with the media content, the first interactive content displaying the first visual avatar.

In this way, the embodiments of the present disclosure can construct the interactive content based on the visual avatar, visualize the interactive content, and improve the interactive experience of the user.

Various example implementations of this solution are described in detail below in conjunction with the accompanying drawings.

### Example Environment

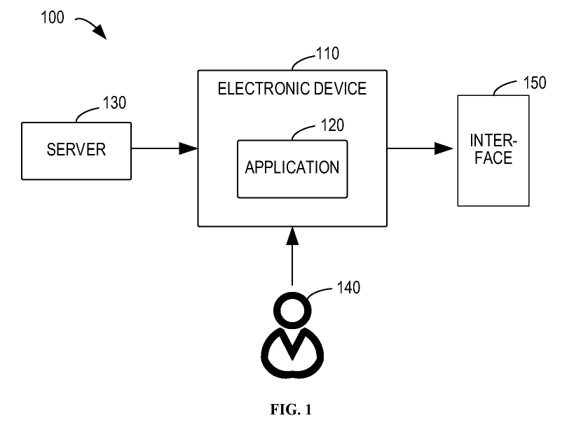

FIG. 1 illustrates a schematic diagram of an example environment 100 in which embodiments of the present disclosure may be implemented. As shown in FIG. 1, the example environment 100 may include an electronic device 110.

In this example environment 100, the electronic device 110 may run an application 120 that supports interface interaction. The application 120 may be any suitable type of application for interface interaction, examples of which may include, but are not limited to: a video application, a social application, a multimedia interaction application, or other suitable applications. A user 140 may interact with the application 120 via the electronic device 110 and/or its attachment device.

In the environment 100 of FIG. 1, if the application 120 is active, the electronic device 110 may present, through the application 120, an interface 150 for supporting interface interaction.

In some embodiments, the electronic device 110 communicates with a server 130 to provide services to the application 120. The electronic device 110 may be any type of a mobile terminal, a fixed terminal, or a portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

The server 130 may be an independent physical server, a server cluster composed of a plurality of physical servers, or a distributed system, or may also be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for the application 120 in the electronic device 110 that supports interface interaction.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In an embodiment of the present disclosure, the server 130 and the electronic device 110 may implement signaling interaction through a communication connection between the server 130 and the electronic device 110.

It should be understood that the structures and functions of the various elements in the environment 100 are described for example purposes only and do not imply any limitation to the scope of the present disclosure.

Some example embodiments of the present disclosure will be described below with continued reference to the accompanying drawings.

### Example Interaction

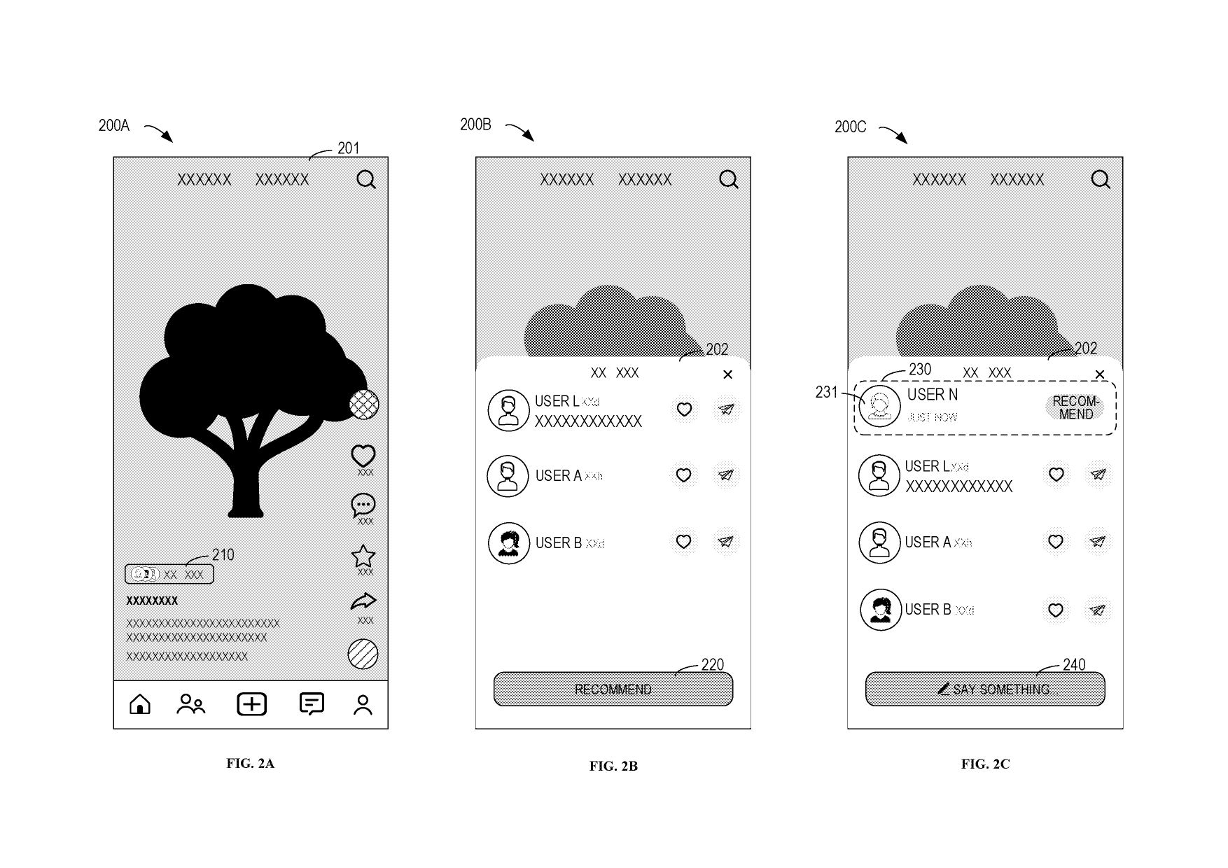

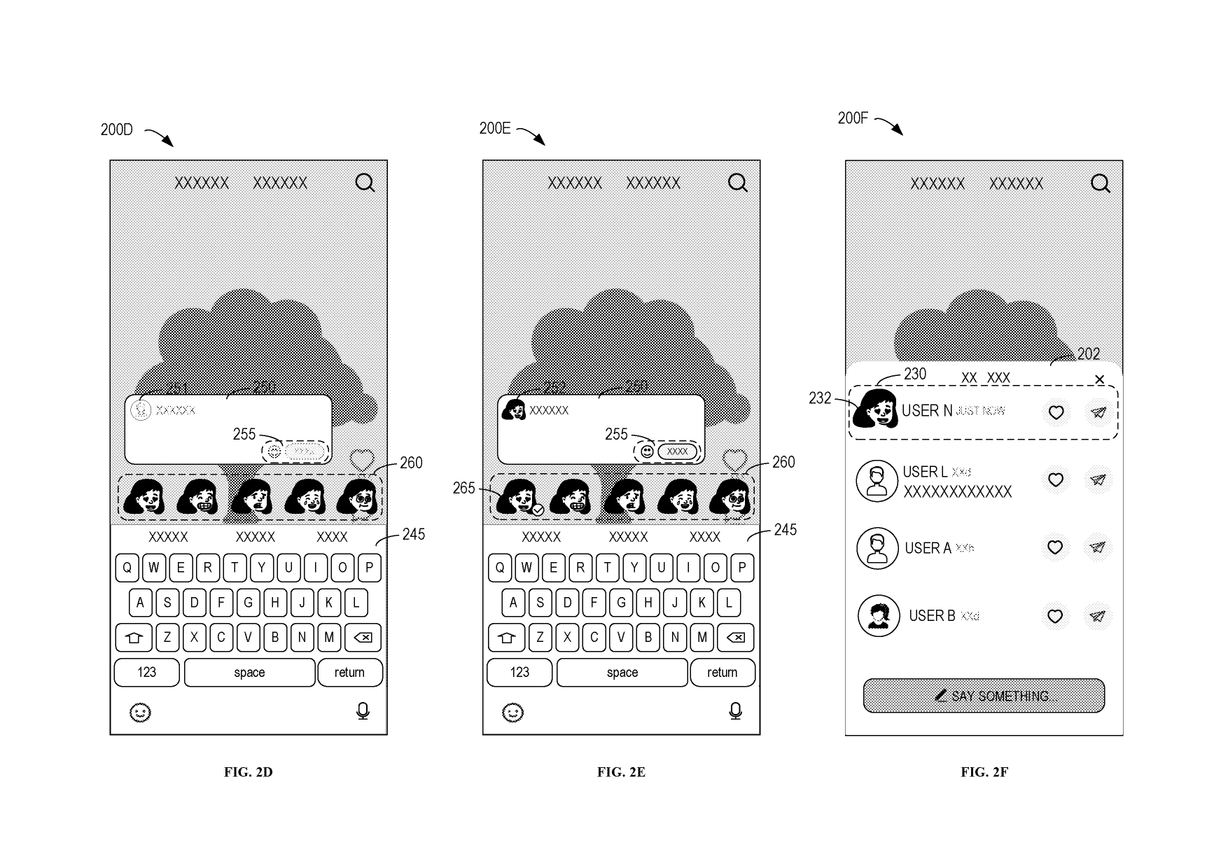

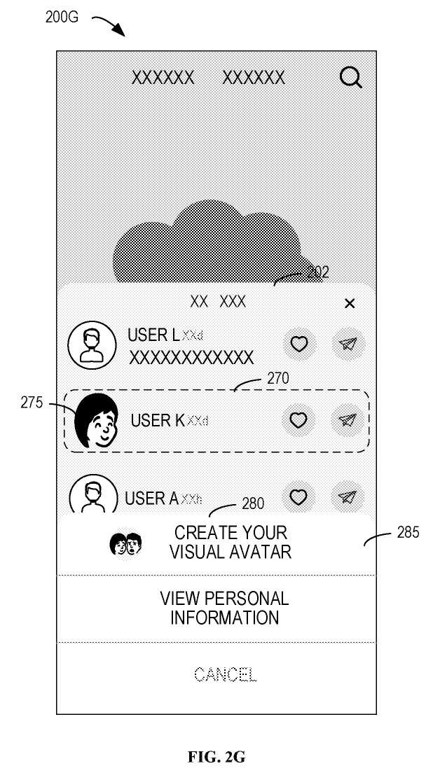

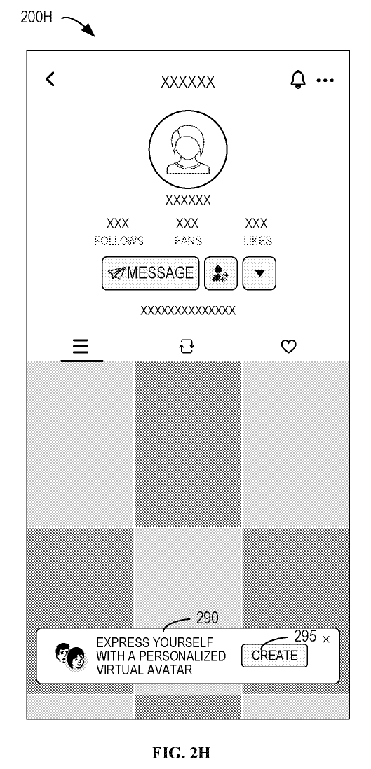

FIGS. 2A-2H illustrate example interfaces 200A-200H according to some embodiments of the present disclosure. The interfaces 200A-200H may be provided, for example, by the electronic device 110 shown in FIG. 1.

In some embodiments, the electronic device 110 may present, in an interactive interface of media content, a first element associated with the media content. The first element indicates an interactive operation of a user on the media content. As an example, the interactive operation may include a sharing operation, a like operation, a comment operation, or a favorite operation and the like of the user on the media content. The corresponding first element may include at least one of an operation control, operation description information, operation result information, and the like of the interactive operation. The following takes the sharing operation as an example to describe.

In some embodiments, the interactive operation causes the media content to be shared to an associated user. As an example, the user's interactive operation on the media content (e.g., a sharing operation) may cause the media content to be shared with other users associated with the user. As an example, a user associated with the user may include other users who follow the user, users who follow each other with the user and/or users in a friendship relationship with the user, and so forth.

In some embodiments, the interactive interface of the media content may include a viewing interface of the media content. As shown in FIG. 2A, the electronic device 110 may present a viewing interface 200A of media content 201. The electronic device 110 may present content of the media content 201 and associated information of the media content 201 (e.g., likes, comments, favorites, forwarding, etc.) in the viewing interface 200A. As an example, the media content 201 may include at least one of video media content, image-text media content, and music media content.

In some embodiments, the electronic device 110 may provide a first sharing control 210 in the viewing interface 200A. For example, the electronic device 110 may present the first sharing control 210 in the viewing interface 200A based on interactive information of the media content 201 satisfying a first condition.

As an example, the first condition may be that the media content 201 is shareable, for example, the user has a sharing permission for the media content 201.

As an example, the first condition may also be at least one piece of historical interactive information of the media content 201, for example, historical sharing information or historical comment information of the at least one user. For example, the first sharing control 210 may display an image identifier of at least one associated user in the historical sharing information.

Based on the first sharing control 210 being triggered, the electronic device 110 may further present an interactive panel associated with the media content 201, for example an interactive panel 202 in an interface 200B shown in FIG. 2B.

Referring to FIG. 2B, the electronic device 110 provides the historical sharing information associated with the media content 201 in the interactive panel 202.

As an example, the historical sharing information in the interactive panel 202 may be a list type information stream.

In some embodiments, if the historical sharing information associated with the media content 201 does not include the historical sharing information of the current user, that is, the current user does not perform a sharing operation for the media content 201, the electronic device 110 provides a second sharing control 220 in the interactive panel 202. The user may trigger the second sharing control 220 to share the media content 201.

As an example, the second sharing control 220 may display operation prompt information such as “recommend” or “share”.

Based on the second sharing control 220 being triggered, the electronic device 110 may update the information in the interactive panel 202. The update result may refer to an interface 200C shown in FIG. 2C.

As shown in FIGS. 2B and 2C, the electronic device 110 adds sharing information 230 of the current user in the interactive panel based on the second sharing control 220 being triggered.

In some embodiments, the electronic device 110 provides association information of the current user in the sharing information 230. As an example, the association information of the current user may include a user name of the current user, a publishing duration of the sharing information 230, and the like, and may further include an image identifier 231 of the current user.

In some embodiments, the electronic device 110 may also switch the second sharing control 220 to the interactive control 240 based on the second sharing control 220 being triggered. As an example, the interactive control 240 may display prompt information such as “Say something” or “Input a comment”. The user may send an interaction request, for example, a comment request or a sharing request, to the electronic device 110 by triggering the interactive control 240.

In some embodiments, the electronic device 110 may receive an interaction request from the user for the media content 201 based on the interactive control 240 being triggered, and switch the interface 200C to an interface 200D shown in FIG. 2D.

Referring to FIG. 2D, the electronic device may provide an input panel 245 in the viewing interface 200D of the media content 201 to receive information input by the user via the input panel 245. As an example, the user may input text information, sticker information (e.g. emoji), voice information, and the like through the input panel 245. For example, the user may edit and input information such as comment content for the media content 201 through the input panel 245.

The electronic device 110 may also provide a preview panel 250 in the viewing interface 200D. The electronic device 110, via the preview panel 250, may present input information received via the input panel 245. Accordingly, the user may view the input information in the preview panel 250.

In some embodiments, the preview panel 250 may also provide an image identifier 251 of the current user and an adding control 255.

For example, in a position adjacent to the image identifier 251 in the preview panel 250, prompt information may also be provided, for example, “Say something” or “Please input a comment” displayed in gray to prompt the user to input content that needs to be expressed.

In some embodiments, the electronic device 110 may set the adding control 255 to a disabled state, for example, a gray-out setting, in response to the information input by the user not being received in the preview panel 250.

As shown in FIG. 2D, the electronic device 110 may also provide a set of visual avatars 260 associated with the current user in an interface 200D. As an example, the electronic device 110 may present the set of visual avatars 260 at a position or area associated with the preview panel 250. As shown in FIG. 2D, the electronic device 110 presents the set of visual avatars 260 in an area between the input panel 245 and the preview panel 250.

In some embodiments, the set of visual avatars 260 includes a plurality of visual avatars associated with a plurality of expression states of a virtual object, for example, including a visual avatar corresponding to any at least one expression or action state of a preset virtual object, such as laughing, crying and the like. The preset virtual object may be selected by the current user from the plurality of virtual objects, or may be created by the user through a model embedded in the application 120 or another way.

In some embodiments, the set of visual avatars 260 may be generated based on virtual avatar data associated with the user.

In some embodiments, the electronic device 110 may present the set of visual avatars 260 in a manner of an information list or information stream. As an example, the user may view, by swiping left and right, other visual avatars that are not completely presented in the current interface; the user may also select a visual avatar to be expressed from the set of visual avatars 260 by clicking (for example, single clicking or double clicking), a long press, swiping (for example, swiping upward, etc. ), and the like.

Referring to FIG. 2E, in response to a target visual avatar 265 in the set of visual avatars 260 being selected, the electronic device 110 replaces the image identifier 251 of the current user in the preview panel 250 with the selected target visual avatar 265 to present an avatar identifier 252.

In some embodiments, the electronic device 110 presents a selection identifier on the target visual avatar 265 from the set of visual avatars 260 in response to the target visual avatar from the set of visual avatars 260 being selected.

In some embodiments, the electronic device 110 may switch the adding control 255 to an enabled state in response to the input information being received via the input panel 245.

In response to the selection of the target visual avatar by the user, the electronic device 110 constructs corresponding interactive content based on at least the target visual avatar. The constructed interactive content displays the selected target visual avatar 265.

As an example, if the information input via the input panel 245 is received in the preview panel 250, the interactive content may be constructed based on the target visual avatar selected by the user with the input information received in the preview panel 250.

In some embodiments, after selecting the target visual avatar 265, the electronic device 110 presents an interface 200F in response to a confirmation operation on the target visual avatar 265.

As an example, the user may realize the confirmation of the target visual avatar 265 by double clicking the target visual avatar 265; the confirmation of the selected visual avatar may also be realized by triggering a confirmation key (for example, an enter key or a return key) in the input panel 245.

Referring to FIG. 2F, the electronic device 110 presents the target visual avatar 265 in the sharing information 230 presented in the interactive panel 202 in response to the confirmation operation on the target visual avatar 265.

As an example, the electronic device 110 replaces the image identifier 231 of the current user in the sharing information 230 with an avatar identifier 232, and visual effect of the avatar identifier 232 is consistent with visual effect of the target visual avatar 265. For example, the electronic device 110 may replace the image identifier 231 with the target visual avatar 265 to present the avatar identifier 232.

In some embodiments, if the electronic device 110 can find a visual avatar preset by the current user, the set of visual avatars 260 may be presented in the interface 200D shown in FIG. 2D; and if the electronic device 110 fails to find the visual avatar associated with the current user, the set of visual avatars may not be directly presented.

In some embodiments, the electronic device 110 may also present an interface 200G shown in FIG. 2G in response to a trigger on the first sharing control 210 in the viewing interface 200A.

Referring to FIG. 2G, in the interactive panel 202 presented by the electronic device 110, the historical sharing information associated with the media content 201 is provided. The historical sharing information includes sharing information of at least one other user on the media content 201.

In some embodiments, the historical sharing information presented by the interactive panel 202 includes at least historical sharing information 270 of a first user, where the historical sharing information 270 includes an avatar identifier 275 of the first user. As an example, the avatar identifier 275 may be a visual avatar of the first user.

In some embodiments, the electronic device 110 presents a creation panel 280 in response to a trigger of the avatar identifier 275 and provides a first creation entry 285 of the visual avatar in the creation panel 280. The user may create at least one visual avatar by triggering the first creation entry 285.

As an example, via the first creation entry 285, the electronic device 110 may provide a set of preset virtual avatars and a set of preset expression identifiers (for example, expressions), and then create at least one visual avatar based on a selection and matching of the at least one virtual avatar and the at least one expression identifier, so that the user selects the at least one visual avatar during sharing media content or other interaction processes.

In some embodiments, the electronic device 110 may present a user detail interface 200H shown in FIG. 2H in response to a trigger on a user control in the viewing interface 200A, or in response to a trigger on the image identifier 231 of the current user in the interface 200C.

Referring to FIG. 2H, the electronic device 110 provides relevant description information and historical work of the current user in the user detail interface 200H.

In some embodiments, the electronic device 110 may also provide a prompt panel 290 in the user detail interface 200H in response to failing to find a visual avatar associated with the current user. As an example, prompt information about the virtual avatar may be provided in the prompt panel 290.

In some embodiments, the electronic device 110 may also provide a second creation entry 295 in the prompt panel 290.

As an example, via the second creation entry 295, the electronic device 110 may provide a set of preset virtual avatars and a set of preset expression identifiers (for example, expressions), and then create at least one visual avatar based on a selection and matching of the at least one virtual avatars and the at least one expression identifier, so that the user selects the at least one visual avatar during sharing media content or other interaction processes.

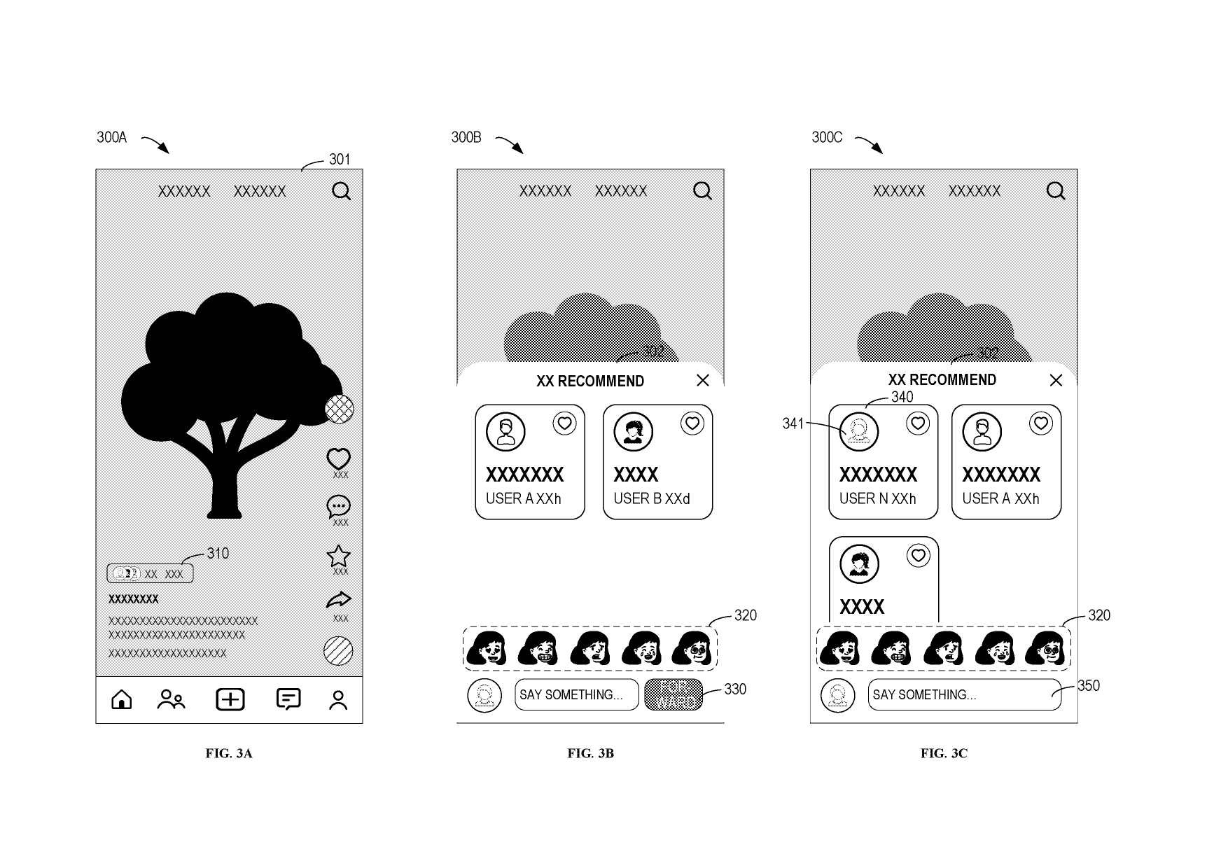

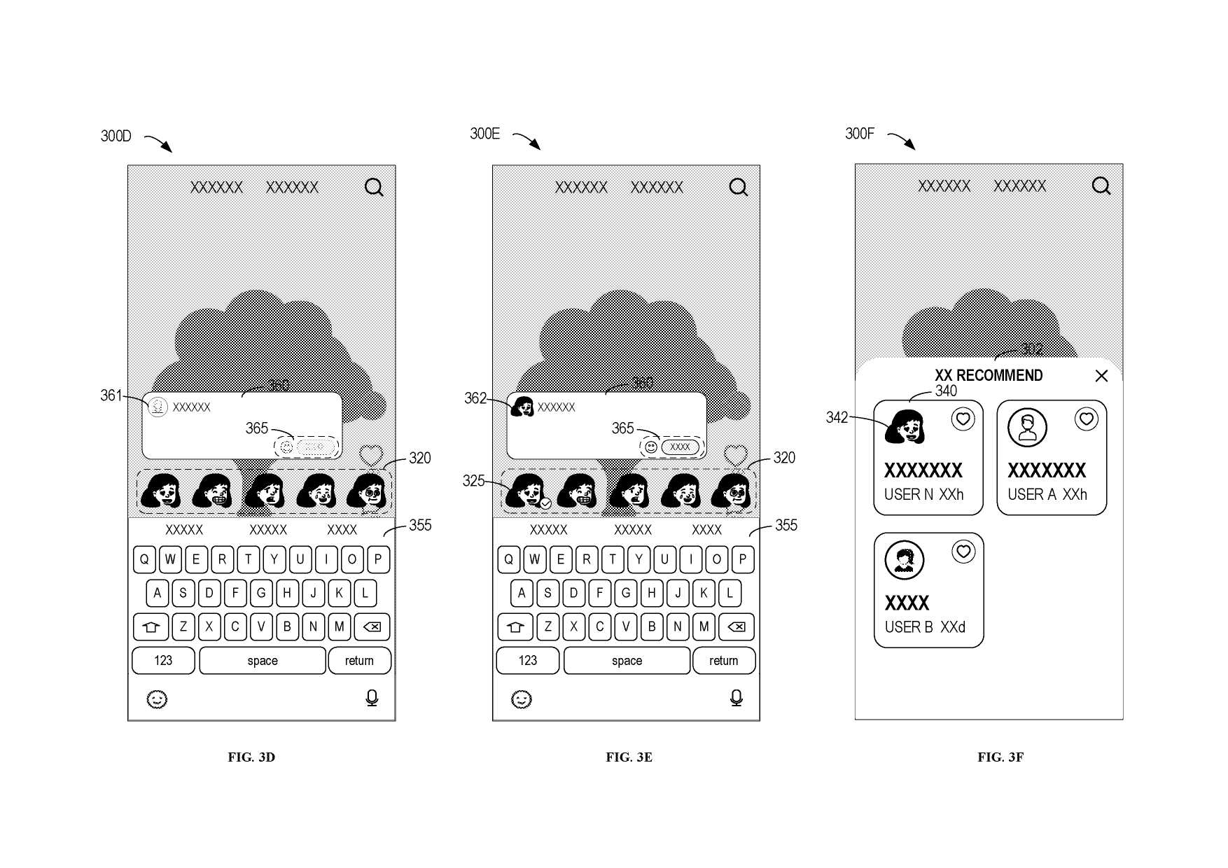

FIGS. 3A-3F illustrate example interfaces 300A-300F according to some embodiments of the present disclosure. The interfaces 300A-300F may be provided, for example, by the electronic device 110 shown in FIG. 1.

As shown in FIG. 3A, the electronic device 110 may present a viewing interface 300A of media content 301. The electronic device 110 may present content of the media content 301 and associated information of the media content 301 (e.g., likes, comments, favorites, forwarding, etc.) in the viewing interface 300A. As an example, the media content 301 may include at least one of video media content, image-text media content, and music media content.

In some embodiments, the electronic device 110 may provide a third sharing control 310 in the viewing interface 300A. For example, the electronic device 110 may present the third sharing control 310 in the viewing interface 300A based on interaction information of the media content 301 satisfying a second condition.

As an example, the second condition may be that the media content 301 is shareable, for example, the user has a sharing permission for the media content 301.

As an example, the second condition may also be at least one piece of historical interactive information of the media content 301, for example, historical sharing information or historical comment information of the at least one user. For example, the third sharing control 310 may display an image identifier of at least one associated user in the historical sharing information.

Based on the third sharing control 310 being triggered, the electronic device 110 may further present an interactive panel associated with the media content 301, for example an interactive panel 302 in an interface 300B shown in FIG. 3B.

Referring to FIG. 3B, the electronic device 110 provides the historical sharing information associated with the media content 301 in the interactive panel 302.

As an example, the historical sharing information in the interactive panel 302 may be presented in a card form. For example, the interactive panel 302 presents an information stream composed of a plurality of card type historical sharing information.

The electronic device 110 may also present a set of visual avatars 320 in the interactive panel 302 in response to finding a visual avatar associated with the current user.

In some embodiments, the set of visual avatars 320 includes a plurality of visual avatars associated with a plurality of expression states of a virtual object. For example, a visual avatar corresponding to any at least one expression or action state such as laughing and crying of a preset virtual object is included. The preset virtual object may be selected by the current user from the plurality of virtual objects, or may be created by the user through a model embedded in the application 120 or another way.

In some embodiments, the set of visual avatars 320 may be generated based on virtual avatar data associated with the user.

In some embodiments, the electronic device 110 may present the set of visual avatars 320 in a manner of an information list or information stream. As an example, the user may view, by swiping left and right, other visual avatars that are not completely presented in the current interface.

In some embodiments, if the historical sharing information associated with the media content 301 does not include the historical sharing information of the current user, that is, the current user does not perform a sharing operation for the media content 301, the electronic device 110 provides a fourth sharing control 330 in the interactive panel 302. The user may trigger the fourth sharing control 330 to share the media content 301.

As an example, the fourth sharing control 330 may display operation prompt information such as “recommend”, “forward”, or “share”.

Based on the fourth sharing control 330 being triggered, the electronic device 110 may update the information in the interactive panel 302, and the updated result may refer to an interface 300C shown in FIG. 3C.

As shown in FIGS. 3B and 3C, the electronic device 110 adds sharing information 340 of the current user in the interactive panel based on the fourth sharing control 330 being triggered.

In some embodiments, the electronic device 110 provides association information of the current user in the sharing information 340. As an example, the association information of the current user may include a user name of the current user, a publishing duration of the sharing information 340, and the like, and may further include an image identifier 341 of the current user.

In some embodiments, the electronic device 110 may further hide the fourth sharing control 330 based on the fourth sharing control 330 being triggered, that is, the electronic device 110 may stop presenting the fourth sharing control 330 in the interface 300C.

As an example, the electronic device 110 may provide an interactive control 350 in the interactive panel 302. For example, the interactive control 350 may display prompt information such as “Say something” or “Input a comment”. The user may send an interaction request, for example, a comment request or a sharing request, to the electronic device 110 by triggering the interactive control 350.

Based on the interactive control 350 being triggered, the electronic device 110 may receive an interaction request from the user for the media content 301, and switch the interface 300C to an interface 300D shown in FIG. 3D.

Referring to FIG. 3D, the electronic device may provide an input panel 355 in the viewing interface 300D of the media content 301 to receive information input by the user via the input panel 355. As an example, the user may input text information, sticker information (e.g. emoji), voice information, and the like through the input panel 355. For example, the user may edit and input information such as comment content for the media content 301 through the input panel 355.

The electronic device 110 may also provide a preview panel 360 in the viewing interface 300D. The electronic device 110, via the preview panel 360, may present input information received via the input panel 355. Accordingly, the user may view the input information in the preview panel 360.

In some embodiments, the preview panel 360 may also provide an image identifier 361 of the current user and an adding control 365.

For example, in a position adjacent to the image identifier 361 in the preview panel 360, prompt information may also be provided, for example, “Say something” or “Please input a comment” displayed in gray to prompt the user to input content that needs to be expressed.

In some embodiments, the electronic device 110 may set the adding control 365 to a disabled state, for example, a gray-out setting, in response to the information input by the user not being received in the preview panel 360.

As shown in FIG. 3D, the electronic device 110 may also provide a set of visual avatars 320 associated with the current user in an interface 300D. As an example, the electronic device 110 may present the set of visual avatars 320 at a position or area associated with the preview panel 360. As shown in FIG. 3D, the electronic device 110 presents the set of visual avatars 320 in an area between the input panel 355 and the preview panel 360.

In some embodiments, the set of visual avatars 320 includes a plurality of visual avatars associated with a plurality of expression states of a virtual object. For example, a visual avatar corresponding to any at least one expression or action state such as laughing and crying of a preset virtual object is included. The preset virtual object may be selected by the current user from the plurality of virtual objects, or may be created by the user through a model embedded in the application 120 or another way.

In some embodiments, the set of visual avatars 320 may be generated based on virtual avatar data associated with the user.

In some embodiments, the electronic device 110 may present the set of visual avatars 320 in a manner of an information list or information stream. As an example, the user may view, by swiping left and right, other visual avatars that are not completely presented in the current interface; the user may also select a visual avatar to be expressed from the set of visual avatars 320 by clicking (for example, single clicking or double clicking), a long press, swiping (for example, swiping upward, etc.), and the like.

Referring to FIG. 3E, in response to a target visual avatar 325 from the set of visual avatars 320 being selected, the electronic device 110 replaces the image identifier 361 of the current user in the preview panel 360 with the selected target visual avatar 325 to present an avatar identifier 362.

In some embodiments, the electronic device 110 presents a selection identifier on the target visual avatar 325 from the set of visual avatars 320 in response to the target visual avatar from the set of visual avatars 320 being selected.

In some embodiments, the electronic device 110 may switch the adding control 365 to an enabled state in response to the input information being received via the input panel 355.

In response to the selection of the target visual avatar by the user, the electronic device 110 constructs corresponding interactive content based on at least the target visual avatar. The constructed interactive content displays the selected target visual avatar 325.

As an example, if the information input via the input panel 355 is received in the preview panel 360, the interactive content may be constructed based on the target visual avatar selected by the user with the input information received in the preview panel 360.

In some embodiments, after selecting the target visual avatar 325, the electronic device 110 presents an interface 300F in response to a confirmation operation on the target visual avatar 325.

As an example, the user may realize the confirmation of the target visual avatar 325 by double clicking the target visual avatar 325; the confirmation of the selected visual avatar may also be realized by triggering a confirmation key (for example, an enter key or a return key) in the input panel 355.

Referring to FIG. 2F, in response to the confirmation operation on the target visual avatar 325, the electronic device 110 replaces the image identifier 341 with an avatar identifier 342 which is determined based on the target visual avatar 325 in the sharing information 340 presented by the interactive panel 302.

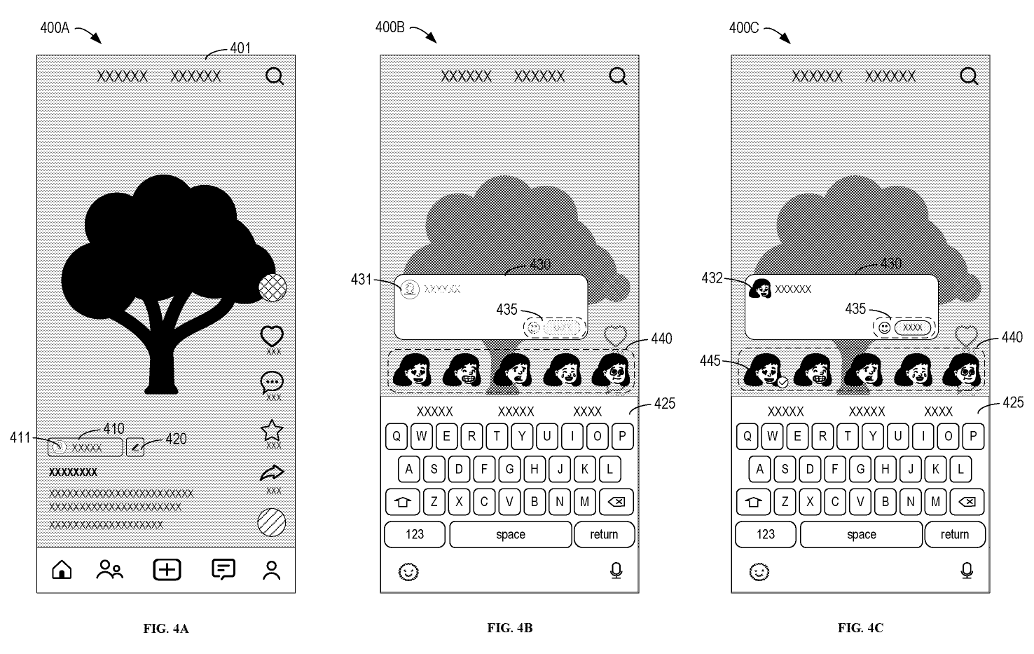

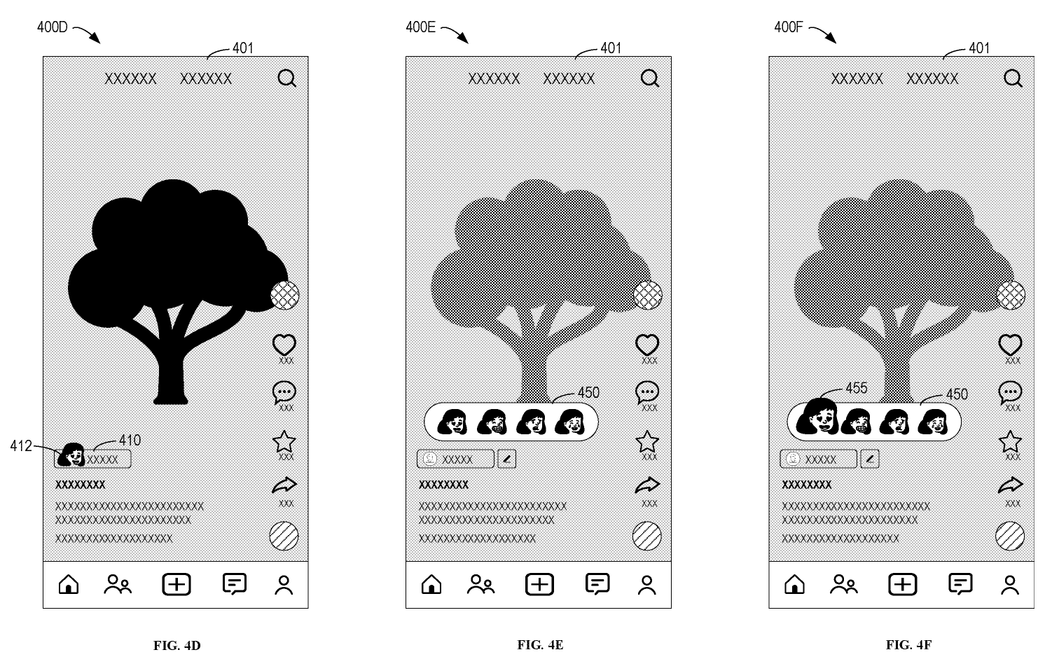

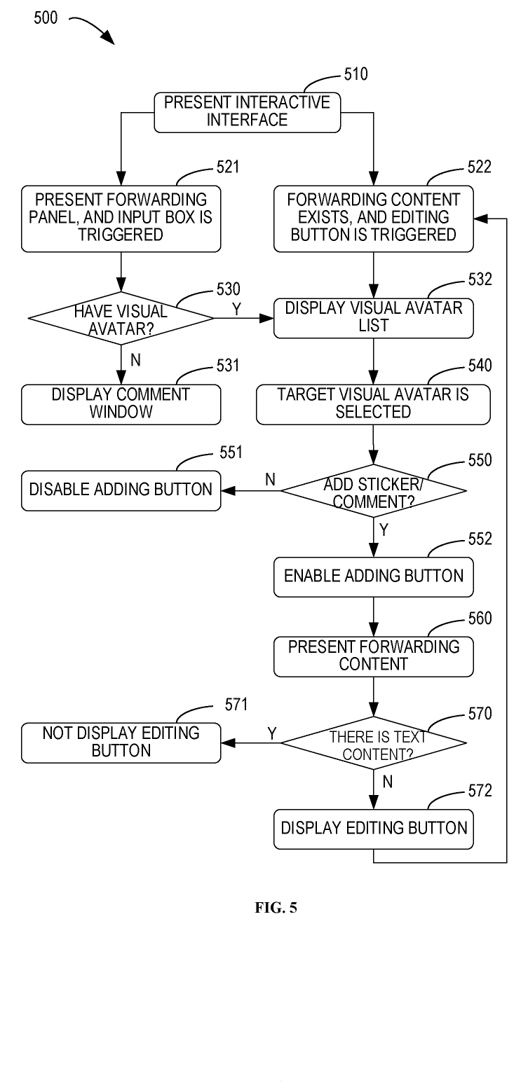

FIGS. 4A-4F illustrate example interfaces 400A-400F according to some embodiments of the present disclosure. The interfaces 400A-400F may be provided, for example, by the electronic device 110 shown in FIG. 1.

As shown in FIG. 4A, the electronic device 110 may present a viewing interface 400A of media content 401. The electronic device 110 may present content of the media content 401 and associated information of the media content 401 (e.g., likes, comments, favorites, forwarding, etc.) in the viewing interface 400A. As an example, the media content 401 may include at least one of video media content, image-text media content, and music media content.

In some embodiments, the electronic device 110 may provide an interactive element 410 for the media content 401 in the viewing interface 400A. As an example, the interactive element 410 may indicate an interactive operation of the current user for the media content, such as a sharing operation, a comment operation, and the like.

As an example, the electronic device 110 may present a user identifier of the current user in the interactive element 410. For example, the user identifier may include an image identifier 411 of the current user, or may include a text identifier (for example, user nickname or comment content).

As an example, the electronic device 110 may also present, in the interactive element 410, at least part of the comment added by the current user for the interactive operation associated with the media content 401. For example, the electronic device 110 may present entire content of the comment in the interactive element 410. For another example, the electronic device 110 may, in response to the length of the comment (e.g., the number of text words) exceeding a predetermined threshold (e.g., “5 words”), present partial content of the comment (e.g., only the first 5 words of the comment) in the interactive element 410.

In some embodiments, the electronic device 110 may also present an interactive control 420 at a position or area associated with the interactive element 410. The user may send an interaction request, for example, a comment request or a sharing request, to the electronic device 110 by triggering the interactive control 420.

In some embodiments, the electronic device 110 may receive an interaction request from the user for the media content 401 based on the interactive control 420 being triggered, and switch the interface 400A to an interface 400B shown in FIG. 4B.

Referring to FIG. 4B, the electronic device may provide an input panel 425 in the viewing interface 400B of the media content 401 to receive information input by the user via the input panel 425. As an example, the user may input text information, sticker information (e.g. emoji), voice information, and the like through the input panel 425. For example, the user may edit and input information such as comment content for the media content 401 through the input panel 425.

The electronic device 110 may also provide a preview panel 430 in the viewing interface 400B. The electronic device 110, via the preview panel 430, may present input information received via the input panel 425. Accordingly, the user may view the input information in the preview panel 430.

In some embodiments, the preview panel 430 may also provide an image identifier 431 of the current user and an adding control 435.

For example, in a position adjacent to the image identifier 431 in the preview panel 430, prompt information may also be provided, for example, “Say something” or “Please input a comment” displayed in gray to prompt the user to input content that needs to be expressed.

In some embodiments, the electronic device 110 may set the adding control 435 to a disabled state, for example, a gray-out setting, in response to the information input by the user not being received in the preview panel 430.

Referring to FIG. 4B, the electronic device 110 may present, in the interface 400B, a set of visual avatars 440 associated with the current user in response to finding the visual avatar associated with the current user. As an example, the electronic device 110 may present the set of visual avatars 440 at a position or area associated with the preview panel 430. As shown in FIG. 4B, the electronic device 110 presents the set of visual avatars 440 in an area between the input panel 425 and the preview panel 430.

In some embodiments, the set of visual avatars 440 includes a plurality of visual avatars associated with a plurality of expression states of a virtual object. For example, a visual avatar corresponding to any at least one expression or action state such as laughing and crying of a preset virtual object is included. The preset virtual object may be selected by the current user from the plurality of virtual objects, or may be created by the user through a model embedded in the application 120 or another way.

In some embodiments, the set of visual avatars 440 may be generated based on virtual avatar data associated with the user.

In some embodiments, the electronic device 110 may present the set of visual avatars 440 in a manner of an information list or information stream. As an example, the user may view, by swiping left and right, other visual avatars that are not completely presented in the current interface; the user may also select a visual avatar to be expressed from the set of visual avatars 440 by clicking (for example, single clicking or double clicking), a long press, swiping (for example, swiping upward, etc. ), and the like.

Referring to FIG. 4C, in response to a target visual avatar 445 from the set of visual avatars 440 being selected, the electronic device 110 replaces the image identifier 431 of the current user in the preview panel 430 with the selected target visual avatar 445 to present an avatar identifier 432.

In some embodiments, the electronic device 110 presents a selection identifier on the target visual avatar 445 in the set of visual avatars 440 in response to the target visual avatar from the set of visual avatars 440 being selected.

In some embodiments, the electronic device 110 may switch the adding control 435 to an enabled state in response to the input information being received via the input panel 425.

In response to the selection of the target visual avatar by the user, the electronic device 110 constructs corresponding interactive content based on at least the target visual avatar. The constructed interactive content displays the selected target visual avatar 445.

As an example, if the information input via the input panel 425 is received in the preview panel 430, the interactive content may be constructed based on the target visual avatar selected by the user with the input information received in the preview panel 430.

In some embodiments, after selecting the target visual avatar 445, the electronic device 110 presents an interface 400D in response to a confirmation operation on the target visual avatar 445.

As an example, the user may realize the confirmation of the target visual avatar 445 by double clicking the target visual avatar 445; the confirmation of the selected visual avatar may also be realized by triggering a confirmation key (for example, an enter key or a return key) in the input panel 445.

Referring to FIG. 4D, the electronic device 110 updates the interactive description information of the interactive element 410 in the viewing interface 400D of the media content 401 in response to the confirmation operation on the target visual avatar 445.

As an example, the electronic device 110 may replace the image identifier 411 of the current user in the interactive element 410 with an avatar identifier 412. The avatar identifier 412 of the current user is determined based on the target visual avatar 445 selected by the current user in the interface 400C.

Referring back to FIG. 4A, in some embodiments, the electronic device 110 finds a visual avatar associated with the current user in response to a trigger on the interactive control 420; and in response to finding the visual avatar associated with the current user, the electronic device 110 may switch the viewing interface 400A to an interface 400E shown in FIG. 4E.

Referring to FIG. 4E, the electronic device 110 presents the set of visual avatars 450 in the viewing interface 400E of the media content 401 in response to a trigger on the interactive control 420 and finding a set of visual avatars associated with the current user.

In some embodiments, the electronic device 110 presents an interface 400F shown in FIG. 4F in response to a triggering on any of the set of visual avatars 450 by the user.

As shown in FIG. 4F, in the interface 400F, the electronic device 110 highlights a target visual avatar 455 in the set of visual avatars 450 in response to a selection (for example, a single click operation) on the target visual avatar 455 from the set of visual avatars 450, for example, the target visual avatar 455 may be highlighted in any implementable dynamic form such as a bouncing form, a zooming form, or the like, or may be highlighted in any implementable static form such as a zoom-in state or a removal queue.

In some embodiments, the electronic device 110 switches the interface 400F to an interface 400D shown in FIG. 4D in response to a confirmation operation performed by the user on the target visual avatar 455 in the interface 400F.

As an example, the electronic device 110 may replace the image identifier 411 of the current user in the interactive element 410 with an avatar identifier 412. The avatar identifier 412 of the current user is determined based on the target visual avatar 455 selected by the current user in the interface 400F.

### Example Processes

FIG. 5 illustrates a flowchart of an example process 500 of implementing interface interaction according to some embodiments of the present disclosure. The process 500 may be implemented at the electronic device 110. The process 500 is described below with reference to FIG. 1.

As shown in FIG. 5, at block 510, the electronic device 110 presents an interactive interface of media content.

As an example, the interactive interface of the media content may refer to an interactive interface 200A of FIG. 2A.

In some embodiments, within the interaction interface, a user may interact by triggering different operation controls. As an example, the electronic device 110 may perform block 521 in response to a sharing control (for example, the sharing control 210 in the interaction interface 200A) in the interaction interface being triggered.

In some embodiments, interactive content of the user and an editing control associated with the interactive content (for example, the editing control 420 in the interface 400A shown in FIG. 4A) may be presented in the interactive interface, and the electronic device 110 may perform block 522.

At block 521, the electronic device 110 presents a forwarding panel that provides an input box. If the input box is triggered, the electronic device 110 performs block 530.

At block 530, the electronic device 110 obtains at least one visual avatar preset by the current user, and if the at least one visual avatar fails to be obtained, the electronic device 110 performs block 531; if the at least one visual avatar is obtained, the electronic device 110 performs block 532.

As an example, the electronic device 110 may search locally or in a cloud and obtain a visual avatar preset by the user.

At block 531, the electronic device 110 displays a comment window in a case that it fails to find a visual avatar of the user.

At block 532, the electronic device 110 may display a visual avatar list of the user in response to finding and obtaining at least one visual avatar of the user.

As an example, the electronic device 110 may display the visual avatar list of the user in the forwarding panel, or may present another interactive panel (for example, an interactive panel embedded in an input panel or a forwarding panel, etc. ), and present the visual avatar list at a position or area associated with the interactive panel.

As an example, in an interface where the visual avatar list is located, an input box and/or an adding button may be provided to receive content such as comment content or stickers input by the user via the input box and/or the adding button.

At block 540, the electronic device 110 monitors whether each candidate visual avatar included in the visual avatar list is selected, and determines that the target visual avatar is selected.

In some implementations, the user after selecting the target visual avatar from each candidate visual avatar of the visual avatar list, may further replace the selected target visual avatar. For example, a first visual avatar is first selected as the target visual avatar, then it is found that a second visual avatar is closer to content to be expressed, and the second visual avatar may be selected again to replace the first visual avatar with the second visual avatar.

After determining that the target visual avatar is selected, the electronic device 110 performs block 550.

At block 550, the electronic device 110 monitors whether the user adds a sticker or comment content, and if no sticker or comment content is detected, the electronic device 110 performs block 351; if any sticker or comment content is detected, the electronic device 110 performs block 552.

At block 551, the electronic device 110 disables the adding button, e.g., set the adding button to a disabled state.

At block 552, the electronic device 110 enables the adding button, e.g., set the adding button to an enabled state.

The electronic device 110 constructs forwarding content based on at least the target visual avatar. For example, if the sticker or the comment content is detected, the forwarding content is constructed based on the target visual avatar with the received sticker or comment content.

At block 560, the electronic device 110 presents the constructed forwarding content.

As an example, the electronic device 110 may present the forwarding content in the forwarding panel, or may present the forwarding content in the interactive interface.

At block 570, the electronic device 110 determines whether there is text content in the forwarding content, if yes, the electronic device 110 performs block 571; otherwise, the electronic device 110 performs block 572.

At block 571, the electronic device 110 does not display an editing button associated with the interaction content in the interactive interface in response to the forwarding content including the text content.

At block 572, the electronic device 110 presents an editing button associated with the interaction content at a position associated with the forwarding content in the interactive interface in response to the forwarding content not including the text content.

In this way, the user can conveniently add text content to the interaction content through the editing button.

In some embodiments, via the editing button, the user may also replace or add a visual avatar. For example, block 522 is performed.

As an example, in the interactive interface presented when the electronic device 110 performs block 510, if the forwarding content is already there, and there is an editing button at a position associated with the forwarding content, the user may add the text content by triggering the editing button, or may add or replace the visual avatar. In this process, the electronic device 110 performs block 522.

At block 522, the electronic device 110 detects the existing forwarding content and its associated editing button in the interactive interface, and the editing button is triggered, and then the electronic device 110 performs block 532.

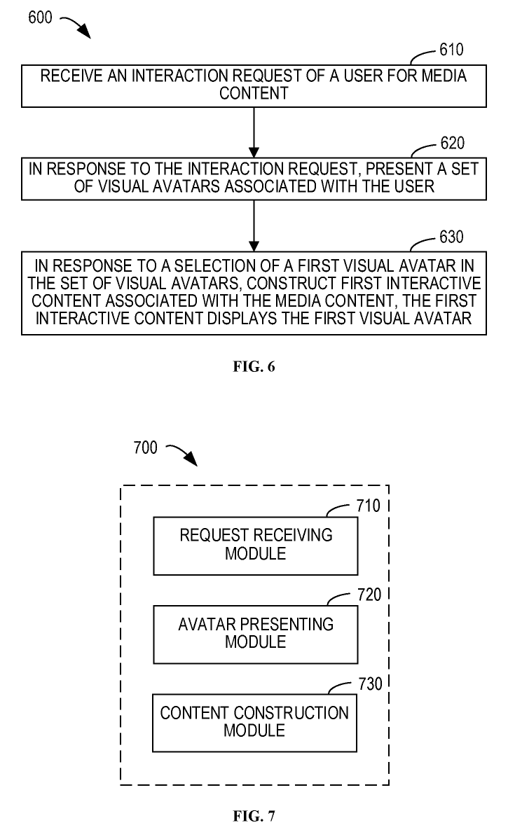

FIG. 6 illustrates a flowchart of an example process 600 of interface interaction according to some embodiments of the present disclosure. The process 600 may be implemented at the electronic device 110. The process 600 is described below with reference to FIG. 1.

As shown in FIG. 6, at block 610, the electronic device 110 receives an interaction request of a user for media content.

In some implementations, the electronic device 110 may receive, via an interactive interface of the media content or an interactive control in the interactive panel, the interaction request of the user for the media content.

As an example, the electronic device 110 may directly or indirectly receive the interaction request of the user via the sharing control 210 in the interface 200A shown in FIG. 2A. For example, the sharing control 210 directly receives the interaction request of the user for the media content 201, or may first present the interface 200C shown in FIG. 2C via the sharing control 210, and then receive the interaction request of the user for the media content 201 via the interactive control 240.

As an example, the electronic device 110 may further receive the interaction request of the user for the media content 301 via the interaction control 350 shown in FIG. 3C; or may receive the interaction request of the user for the media content 401 via the interaction control 420 in the interface 400A shown in FIG. 4A.

At block 620, the electronic device 110 presents a set of visual avatars associated with the user in response to the interaction request.

As an example, the set of visual avatars associated with the user may be a plurality of candidate visual avatars pre-configured by the user.

As an example, the electronic device 110 may present the set of visual avatars 260 associated with the user in an associated position of the input panel 250 in the interface 200D shown in FIG. 2D, may also present the set of visual avatars 320 associated with the user in the interactive panel 302 shown in FIG. 3B, may also present the set of visual avatars 440 in the interface 400B, and may also present the set of visual avatars 450 associated with the user in the interface 400E.

At block 630, the electronic device 110 constructs first interactive content associated with the media content in response to a selection of a first visual avatar from the set of visual avatars. The first interactive content displays the first visual avatar.

As an example, the constructed first interaction content associated with the media content may be any interactive content such as comment content and forwarding content, or may be interaction content in a commenting or the forwarding process with another associated user (for example, a friend user).

In the solution provided by the embodiments of the present disclosure, a set of visual avatars associated with a user are presented based on an interaction request of the user for media content, and interactive content associated with the media content is constructed based on a selection of the user of one of the visual avatars and the interactive content displays the visual avatar. In this way, the solution can visualize the interactive content associated with the media content, improve the diversified display effect of the interactive content, and improve interactive experience of the user.

In some embodiments of the present disclosure, the set of visual avatars is generated based on virtual avatar data associated with the user.

According to the solution, the visual avatar is generated based on the virtual avatar data associated with the user, the virtual avatar can be more attached to the virtual avatar of the user, personalization of the virtual avatar is realized, thereby improving the personalized display effect of the interactive content and the user interactive experience.

In some embodiments of the present disclosure, the set of visual avatars includes a plurality of visual avatars associated with a plurality of expression states of a virtual avatar.

According to the solution, the visual avatar is determined based on the plurality of expression states corresponding to the virtual avatar, this may improve interactivity and diversity of the visual avatar, thereby improving the interactivity and diversity of the interactive content and enhancing the user experience.

In some embodiments of the present disclosure, receiving the interaction request of the user for the media content includes: presenting an interactive panel of the media content, the interactive panel configured to display interactive content associated with the media content; and receiving, via a first interactive control in the interactive panel, the interaction request of the user for the media content.

As an example, the interactive panel may refer to the interactive panel 202 in the interfaces shown in FIGS. 2B or 2C, or the interactive panel 302 shown in FIGS. 3B and 3C. The interactive content associated with the media content may refer to the sharing information 230 in FIG. 2C or the sharing information 340 shown in FIG. 3C. The first interactive control may refer to the interactive control 240 in FIG. 2C or the interactive control 350 shown in FIG. 3C.

According to the interface interactive method of the solution, the interaction request of the user for the media content is received via the first interactive control in the interactive panel of the media content, and accuracy of the interaction request can be improved.

In some embodiments of the present disclosure, the user is a first user, and the process 600 further includes: displaying, in the interactive panel, second interactive content associated with the media content, the second interactive content being associated with the second user, where the second interactive content includes an identifier display area, and the identifier display area is configured to display an image identifier of the second user or a second visual avatar associated with the second user.

For example, the interactive panel may refer to the interactive panel 202 shown in FIG. 2G, the second interactive content may refer to the historical sharing information 270, and the second visual avatar may refer to the visual avatar shown in the avatar identifier 275.

According to the solution, the interactive content for the same media content by different users may be displayed in the interactive panel, and visual avatars of other users may be provided, personalized and diversified presentation of the interactive content is further improved, and the user experience is improved.

In some embodiments of the present disclosure, receiving the interaction request of the user for the media content includes: in response to a sharing request from the user for the media content, presenting a second interactive control in a viewing interface of the media content; and receiving, via the second interaction control in the viewing interface, the interaction request from the user for the media content.

As an example, the viewing interface of the media content may refer to the viewing interface 400A shown in FIG. 4A, and the second interactive control may refer to the interactive control 420.

According to the solution of the embodiments of the present disclosure, the second interactive control can be provided in the viewing interface of the media content, and the interaction request of the user for the media content is directly received based on the second interactive control, the convenience of the interactive operation can be improved, and the interaction efficiency is improved.

In some embodiments of the present disclosure, the sharing request includes a trigger of a sharing control in the viewing interface, and the process 600 further includes: in response to the sharing request, updating the sharing control in the viewing interface to present sharing description information, the sharing description information including an image identifier of the user; and in response to the selection of the first visual avatar from the set of visual avatars, updating the sharing description information to replace the image identifier with the selected first visual avatar.

For example, the sharing description information may refer to the information indicated or presented by the interactive element 410 shown in FIGS. 4A or 4D; the image identifier of the user may refer to the image identifier 411 shown in FIG. 4A. The replaced first visual avatar may refer to the avatar identifier 412 in FIG. 4D.

According to the interface interactive method provided by the embodiments of the present disclosure, the selected visual avatar may be directly updated and presented in the sharing description information based on the selection of the visual avatar, the personalized degree and diversity of the sharing description information are improved, and the interactive experience of the user is improved.

In some embodiments of the present disclosure, in response to the interaction request, presenting the set of visual avatars associated with the user includes: presenting an input control in response to the interaction request; and presenting the set of visual avatars in association with the input control.

As an example, the input control may refer to the interactive control 240 shown in FIG. 2C, or may refer to the input panel 245 or the preview panel 250 shown in FIG. 2D.

In this solution, the set of visual avatars associated with the user is associated with the input control, so that the presentation ways of the visual avatars can be effectively expanded, selection efficiency of the user on the visual avatars is improved, and the interactive experience of the user is improved.

In some embodiments of the present disclosure, the first interactive content further displays input content obtained via the input control.

In this way, the embodiments of the present disclosure can effectively improve content richness of the first interactive content, and improve the interactive experience of the user for the media content.

In some embodiments of the present disclosure, the input content includes comment content associated with the interaction request.

In this way, the embodiments of the present disclosure can effectively improve content richness of the first interactive content, and improve the interactive experience of the user for the media content.

In some embodiments of the present disclosure, the input control presents an image identifier of the user, and the process 600 further includes: in response to a selection of the first visual avatar, replacing the image identifier presented in the input control with the first visual avatar.

For example, the input control may refer to the preview panel 250 shown in FIG. 2D, and the image identifier may refer to the image identifier 251. The first visual avatar may refer to the target visual avatar 265 shown in FIG. 2E or the visual avatar indicated by the replaced avatar identifier 252.

In this solution, the image identifier of the user may be replaced with the selected visual avatar in the input control, so that preview of the presentation effect of the selected visual avatar can be quickly achieved, so that the user can replace the unsatisfied visual avatar, and the user experience is improved.

In some embodiments of the present disclosure, in response to the interaction request, presenting the set of visual avatars associated with the user includes: in response to the user not being associated with corresponding virtual avatar data, presenting an avatar creation entry; based on the avatar creation entry, triggering a construction of virtual avatar data corresponding to the user; and presenting the set of visual avatars generated based on the virtual avatar data.

As an example, the avatar creation entry may refer to the first creation entry 285 shown in FIG. 2G or the second creation entry 295 shown in FIG. 2H.

According to the solution provided by the embodiments of the invention, the avatar creation entry can be provided for the user to quickly construct the virtual avatar data in a case that the user does not associate the virtual avatar data, and the associated visual avatar is created accordingly, a use requirement of the user on the visual avatar is met, creation ways of the visual avatar is expanded, creation efficiency of the visual avatar is improved, and the interactive experience of the user is improved.

### Example Apparatus and Apparatus

Embodiments of the present disclosure also provide a corresponding apparatus for implementing the above method or process. FIG. 7 illustrates a schematic structural block diagram of an example apparatus 700 for interface interaction according to some embodiments of the present disclosure. The apparatus 700 may be implemented as or included in the electronic device 110. The various modules/components in the apparatus 700 may be implemented by hardware, software, firmware, or any combination thereof.

As shown in FIG. 7, the apparatus 700 includes a request receiving module 710, an avatar presenting module 720, and a content construction module 730. The request receiving module 710 is configured to receive an interaction request of a user for media content; the avatar presenting module 720 is configured to present, in response to the interaction request, a set of visual avatars associated with the user; and the content construction module 730 is configured to, in response to selection of a first visual avatar from the set of visual avatars, construct first interactive content associated with the media content, where the first interactive content displays the first visual avatar.

In some embodiments of the present disclosure, the set of visual avatars is generated based on virtual avatar data associated with the user.

In some embodiments of the present disclosure, the set of visual avatars includes a plurality of visual avatars associated with a plurality of expression states of the virtual avatar.

In some embodiments of the present disclosure, the request receiving module 710 is configured to: present an interactive panel of the media content, the interactive panel configured to display interactive content associated with the media content; and receive, via a first interactive control in the interactive panel, the interaction request of the user for the media content.

In some embodiments of the present disclosure, the user is a first user, and the apparatus 700 further includes a content presenting module configured to: display, in the interactive panel, second interactive content associated with the media content, the second interactive content is associated with a second user, where the second interactive content includes an identifier display area, and the identifier display area is configured to display an image identifier of the second user or a second visual avatar associated with the second user.

In some embodiments of the present disclosure, the request receiving module 710 is configured to: in response to a sharing request from the user for the media content, present a second interactive control in a viewing interface of the media content; and receive, via the second interactive control in the viewing interface, the interaction request from the user for the media content.

In some embodiments of the present disclosure, the sharing request includes a trigger of a sharing control in the viewing interface, and the apparatus 700 further includes a module for performing the following process: in response to the sharing request, updating the sharing control in the viewing interface to present sharing description information, the sharing description information including an image identifier of the user; and in response to the selection of the first visual avatar from the set of visual avatars, updating the sharing description information to replace the image identifier with the selected first visual avatar.

In some embodiments of the present disclosure, in response to the interaction request, presenting the set of visual avatar associated with the user includes: presenting an input control in response to the interaction request; and presenting the set of visual avatar in association with the input control.

In some embodiments of the present disclosure, the first interactive content further displays input content obtained via the input control.

In some embodiments of the present disclosure, the input content includes comment content associated with the interaction request.

In some embodiments of the present disclosure, the input control presents an image identifier of the user, and the apparatus 700 further includes an identifier replacing module configured to, in response to a selection of the first visual avatar, replace the image identifier presented in the input control with the first visual avatar.

In some embodiments of the present disclosure, in response to the interaction request, presenting the set of visual avatars associated with the user includes: in response to the user not being associated with corresponding virtual avatar data, presenting an avatar creation entry; based on the avatar creation entry, triggering a construction of virtual avatar data corresponding to the user; and presenting the set of visual avatars generated based on the virtual avatar data.

In the apparatus 700 provided in the embodiments of the present disclosure, a specific processing process of each module and the technical effects brought by the modules may refer to the related description of the foregoing example process 600, and details are not described herein again.

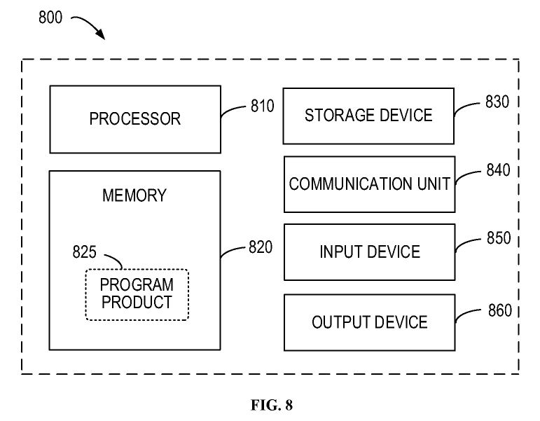

As shown in FIG. 8, an electronic device 800 is in a form of a general-purpose electronic device. Components of the electronic device 800 may include, but are not limited to, one or more processors or processing units 810, memories 820, storage devices 830, one or more communication units 840, one or more input devices 850, and one or more output devices 860. The processor 810 may be an actual or virtual processor and capable of performing various processes according to programs stored in the memory 820. In a multiprocessor system, a plurality of processors performs computer-executable instructions in parallel to improve parallel processing capabilities of the electronic device 800.

The electronic device 800 typically includes a plurality of computer storage media. Such media may be any available media accessible to the electronic device 800, including, but not limited to, volatile and non-volatile media, removable and non-removable media. The memory 820 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. Storage device 830 may be a removable or non-removable medium and may include a machine-readable medium, such as a flash drive, magnetic disk, or any other medium, which may be capable of storing information and/or data and may be accessed within the electronic device 800.

The electronic device 800 may further include additional removable/non-removable, volatile/non-volatile storage media. Although not shown in FIG. 7, a disk drive for reading or writing from a removable, non-volatile magnetic disk (e.g., a “floppy disk”) and an optical disk drive for reading or writing from a removable, non-volatile optical disk may be provided. In these cases, each drive may be connected to a bus (not shown) by one or more data media interfaces. The memory 820 may include a computer program product 825 having one or more program modules configured to perform various methods or acts of various embodiments of the present disclosure.

The communication unit 840 is configured to communicate with other electronic devices through a communication medium. Additionally, the functionality of components of the electronic device 800 may be implemented in a single computing cluster or a plurality of computing machines capable of communicating over a communication connection. Thus, the electronic device 800 may operate in a networked environment using logical connections with one or more other servers, network personal computers (PCs), or another network node.

The input device 850 may be one or more input devices such as a mouse, a keyboard, a trackball, or the like. The output device 860 may be one or more output devices, such as a display, a speaker, a printer, or the like. The electronic device 800 may also communicate with one or more external devices (not shown) through the communication unit 840 as needed, the external devices such as storage devices, display devices, etc. , communicate with one or more devices that enable a user to interact with the electronic device 800, or communicate with any device (e.g., a network card, a modem, etc. ) that enables the electronic device 800 to communicate with one or more other electronic devices. Such communication may be performed via an input/output (I/O) interface (not shown).

According to example implementations of the present disclosure, a computer-readable storage medium having computer executable instructions stored thereon is provided, where the computer executable instructions are executed by a processor to implement the method described above. According to example implementations of the present disclosure, a computer program product is further provided, the computer program product being tangibly stored on a non-transitory computer-readable medium and including computer executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowcharts and/or block diagrams, and combinations of blocks in the flowcharts and/or block diagrams, may be implemented by computer-readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce apparatuses to implement the functions/acts specified in the flowcharts and/or block diagrams. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowcharts and/or block diagrams.

The computer-readable program instructions may be loaded onto a computer, other programmable data processing apparatuses, or other devices, such that a series of operational steps are performed on a computer, other programmable data processing apparatuses, or other devices to produce a computer-implemented process, thereby enabling the instructions executed on a computer, other programmable data processing apparatuses, or other devices to implement the functions/acts specified in the flowcharts and/or block diagrams block or blocks.

The flowcharts and block diagrams in the drawings show architecture, functionality, and operation of possible implementations of systems, methods, and computer program products according to various implementations of the present disclosure. In this regard, each block in the flowcharts or block diagrams may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in a reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or acts, or may be implemented in a combination of dedicated hardware and computer instructions.

Various implementations of the present disclosure have been described above, and the above descriptions are, for example, not exhaustive, and are not limited to the implementations disclosed. Many modifications and variations without departing from the scope and spirit of the various implementations illustrated will be apparent to those of ordinary skill in the art. Selection of the terms used herein is intended to best explain the principles of the implementations, practical applications, or improvements to techniques in the marketplace, or to enable others of ordinary skill in the art to understand the various implementations disclosed herein.

1. A method for interface interaction, comprising:
receiving an interaction request of a user for media content;
presenting, in response to the interaction request, a set of visual avatars associated with the user; and
constructing, in response to a selection of a first visual avatar from the set of visual avatars, first interactive content associated with the media content, wherein the first interactive content displays the first visual avatar.

2. The method of claim 1, wherein the set of visual avatars is generated based on virtual avatar data associated with the user.

3. The method of claim 1, wherein the set of visual avatars comprises a plurality of visual avatars associated with a plurality of expression states of a virtual object.

4. The method of claim 1, wherein receiving the interaction request of the user for the media content comprises:
presenting an interactive panel of the media content, the interactive panel configured to display interactive content associated with the media content; and
receiving, via a first interactive control in the interactive panel, the interaction request of the user for the media content.

5. The method of claim 4, wherein the user is a first user, and the method further comprises:
displaying, in the interactive panel, second interactive content associated with the media content, wherein the second interactive content is associated with a second user, the second interactive content comprises an identifier display area, and the identifier display area is configured to display an image identifier of the second user or a second visual avatar associated with the second user.

6. The method of claim 1, wherein receiving the interaction request of the user for the media content comprises:
presenting, in response to a sharing request from the user for the media content, a second interactive control in a viewing interface of the media content; and
receiving the interaction request from the user for the media content via the second interactive control in the viewing interface.

7. The method of claim 6, wherein the sharing request comprises a trigger of a sharing control in the viewing interface, and the method further comprises:
updating, in response to the sharing request, the sharing control in the viewing interface to present sharing description information, the sharing description information comprising an image identifier of the user; and
updating, in response to the selection of the first visual avatar from the set of visual avatars, the sharing description information to replace the image identifier with the selected first visual avatar.

8. The method of claim 1, wherein presenting, in response to the interaction request, the set of visual avatars associated with the user comprises:
presenting an input control in response to the interaction request; and
presenting the set of visual avatars in association with the input control.

9. The method of claim 8, wherein the first interactive content further displays input content obtained via the input control.

10. The method of claim 9, wherein the input content comprises comment content associated with the interaction request.

11. The method of claim 8, wherein the input control presents an image identifier of the user, and the method further comprises:
replacing, in response to a selection of the first visual avatar, the image identifier presented in the input control with the first visual avatar.

12. The method of claim 1, wherein presenting, in response to the interaction request, the set of visual avatars associated with the user comprises:
presenting an avatar creation entry in response to the user not being associated with corresponding virtual avatar data;
triggering, based on the avatar creation entry, a construction of virtual avatar data corresponding to the user; and
presenting the set of visual avatars generated based on the virtual avatar data.

13. An electronic device, comprising:
at least one processor; and
at least one memory coupled to the at least one processor and storing instructions for execution by the at least one processor, the instructions, when executed by the at least one processor, causing the electronic device to perform acts comprising:
receiving an interaction request of a user for media content;
presenting, in response to the interaction request, a set of visual avatars associated with the user; and
constructing, in response to a selection of a first visual avatar from the set of visual avatars, first interactive content associated with the media content, wherein the first interactive content displays the first visual avatar.

14. The electronic device of claim 13, wherein the set of visual avatars is generated based on virtual avatar data associated with the user.

15. The electronic device of claim 13, wherein the set of visual avatars comprises a plurality of visual avatars associated with a plurality of expression states of a virtual object.

16. The electronic device of claim 13, wherein receiving the interaction request of the user for the media content comprises:
presenting an interactive panel of the media content, the interactive panel configured to display interactive content associated with the media content; and
receiving, via a first interactive control in the interactive panel, the interaction request of the user for the media content.

17. The electronic device of claim 16, wherein the user is a first user, and the acts further comprise:
displaying, in the interactive panel, second interactive content associated with the media content, wherein the second interactive content is associated with a second user, the second interactive content comprises an identifier display area, and the identifier display area is configured to display an image identifier of the second user or a second visual avatar associated with the second user.

18. The electronic device of claim 13, wherein receiving the interaction request of the user for the media content comprises:
presenting, in response to a sharing request from the user for the media content, a second interactive control in a viewing interface of the media content; and
receiving the interaction request from the user for the media content via the second interactive control in the viewing interface.

19. The electronic device of claim 18, wherein the sharing request comprises a trigger of a sharing control in the viewing interface, and the acts further comprise:
updating, in response to the sharing request, the sharing control in the viewing interface to present sharing description information, the sharing description information comprising an image identifier of the user; and
updating, in response to the selection of the first visual avatar from the set of visual avatars, the sharing description information to replace the image identifier with the selected first visual avatar.

20. A non-transitory computer-readable storage medium having a computer program stored thereon, the computer program being executable by a processor to perform acts comprising:
receiving an interaction request of a user for media content;
presenting, in response to the interaction request, a set of visual avatars associated with the user; and
constructing, in response to a selection of a first visual avatar from the set of visual avatars, first interactive content associated with the media content, wherein the first interactive content displays the first visual avatar.
